(19) United States
(12) Patent Application Publication
(10) Pub. No.: US 2012/0099978 A1
(43) Pub. Date: Apr. 26, 2012

(54) Turbine Component Having Easily Removable Protective Layer, Set of Turbine Components, a Turbine and a Method for Protecting a Turbine Component

(76) Inventors: Roman Beyer, Berlin (DE); Boris Bublath, Berlin (DE); Ingo Just, Rangsdorf (DE); Thomas Podgorski, Oranienburg OT Lehnitz (DE)

(21) Appl. No.: 13/147,686

(22) PCT Filed: Feb. 4, 2010
(86) PCT No.: PCT/EP2010/050556

§ 371 Date: Oct. 21, 2011

(30) Foreign Application Priority Data
Feb. 4, 2009 (EP) 09001524.9

(51) Int. Cl. F01D 25/00; B23P 17/00

(52) U.S. Cl. 415/197; 29/888

(57) ABSTRACT

Turbine components are often shipped individually and are not shipped assembled into a turbine. To this end, the turbine blade has to be protected of external stresses and external damage. This is done by an easily removable protective coating that easily evaporates during the first operation of the newly produced or restored component, so that the protective coating does not have to be removed in an additional operational step before installation.

### CROSS REFERENCE TO RELATED APPLICATIONS

This application is the US National Stage of International Application No. PCT/EP2008/050556, filed Feb. 4, 2010 and claims the benefit thereof. The International Application claims the benefits of European. Patent Office application No. 09001524.9 EP filed Feb. 4, 2009. All of the applications are incorporated by reference herein in their entirety.

### FIELD OF INVENTION

The invention relates to a turbine component with an easily removable protective coating, a set of turbine components, a turbine and a method for protecting a component.

### BACKGROUND OF INVENTION

Turbine blades are often provided with metallic or ceramic protective layers for protection from oxidation or corrosion and from excessive introduction of heat, and are either shipped while fitted in a turbine or, in case of doubt, are shipped individually or multiply to allow them to be newly fitted again in situ in a plant.

Similarly, turbine blades have film cooling holes, which are necessary since the cooling makes a higher operating temperature of the turbine blade possible.

During transit, it may happen that the ceramic layer becomes scratched, and this may cause a crack if there is thermal stress. Similarly, the film cooling holes may be clogged by dirt and prevent the emergence of cooling air during operation.

### SUMMARY OF INVENTION

It is therefore the object of the invention to solve the aforementioned problems.

The invention is achieved by a turbine component with an easily removable layer as claimed in the claims, turbine components as claimed in the claims, a set of turbine components as claimed in the claims, a turbine as claimed in the claims and a method as claimed in the claims.

### BRIEF DESCRIPTION OF THE DRAWINGS

Further advantageous measures that can be combined with one another as desired in order to achieve further advantages are listed in the subclaims.

FIGS. 1, 2, 3 and 4 show exemplary embodiments of a turbine blade,

FIG. 5 shows a gas turbine,

FIG. 6 shows a turbine blade and

FIG. 7 shows a combustion chamber,

FIG. 8 shows a list of superalloys.

The examples listed in the figures and in the description only represent exemplary embodiments of the invention.

### DETAILED DESCRIPTION OF INVENTION

FIG. 1 shows a turbine component 1, 120, 130, 155 with an outer hole 7, which is adjacent an outer surface 13 of a substrate 4. The invention is not restricted to turbine components.

An outer hole 7 means a hole in an outer wall of a hollow turbine component 1, 120, 130, 155.

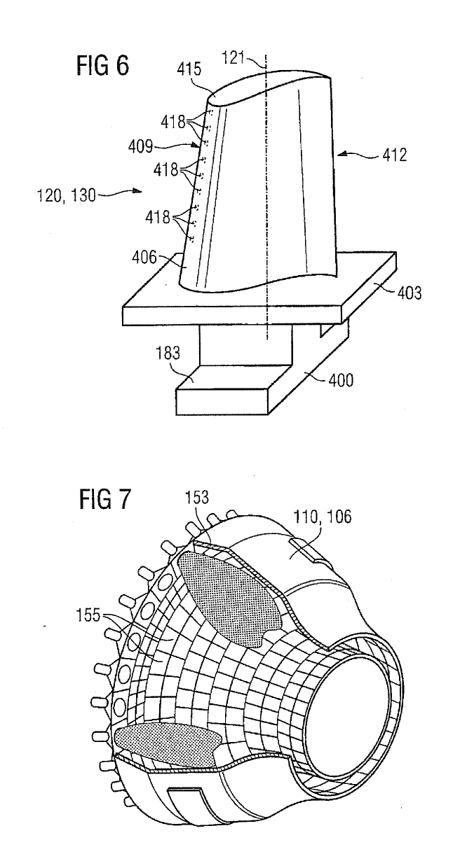

The hole 7 is preferably a through-hole 7, that is to say a film cooling hole in the case of a turbine blade 120, 130 (FIG. 6) or a combustion chamber element 155 (FIG. 7).

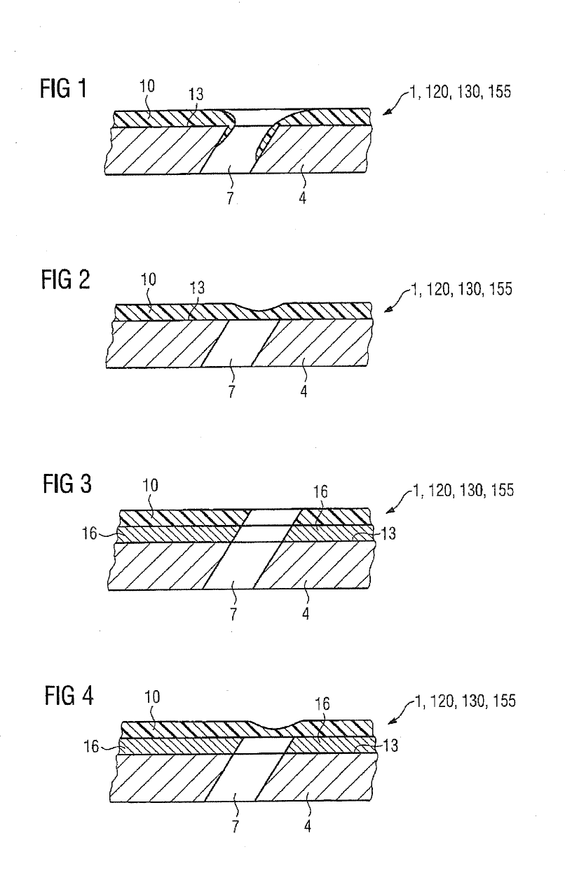

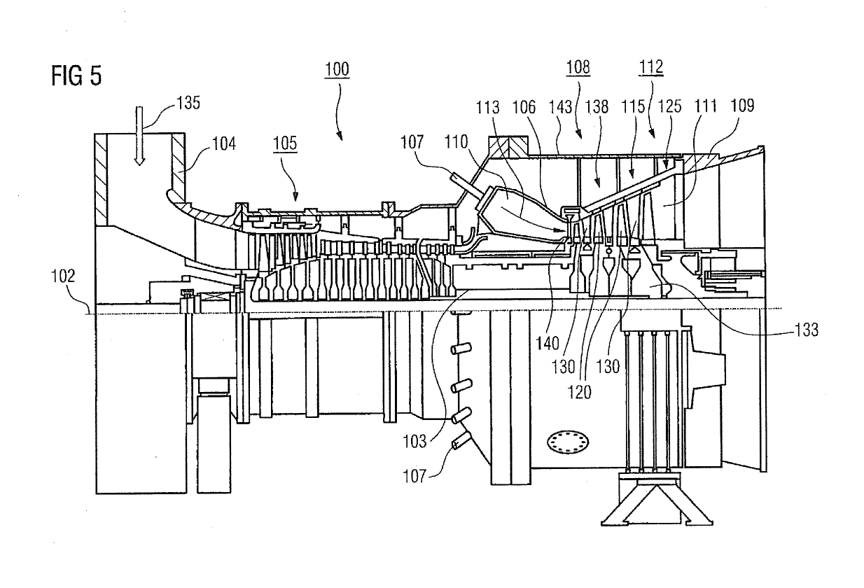

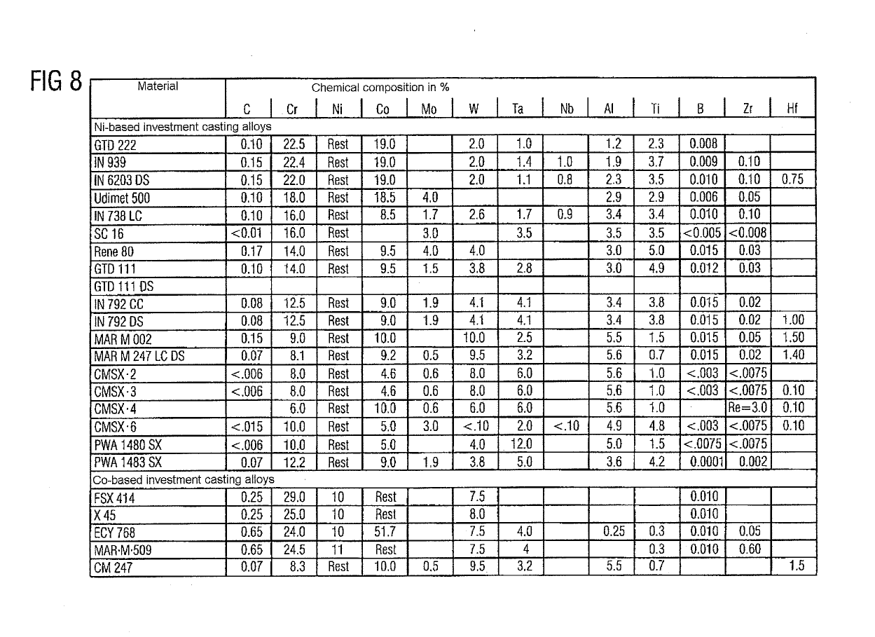

The part that is identified by the reference numeral 4 is the substrate 4 of a superalloy (FIG. 8) and preferably also has metallic and/or ceramic protective coatings 16 (FIGS. 3 and 4), which are not represented in any more specific detail in FIGS. 1 and 2.

The turbine component 1, 120, 130, 155 is used at high operating temperatures, at least 700° C., in particular at least 850° C.

A final, further, outermost layer 10 is applied on the surface 13 of the substrate 4 or the metallic coating 16 (MCrAlY coating) or the ceramic coating 16.

The outermost coating 10 can be easily removed at removal temperatures well below the operating temperature of the component 1, 120, 130, 135 and preferably consists of an organic material, in particular of a polymer.

The high-temperature-resistant polymers are known from the prior art, and so too is the coating of the component 1, 120, 130, 155 with the polymer. Coming into consideration as polymers are polyamides (Aurum), PEEK or PEK (polyether ketones).

The protective coating 10 may preferably contain at least one, particularly only one, dye (preferably inorganic material).

The coating 10 may preferably leave the film cooling hole 7 open (FIGS. 1 and 3) or preferably also cover the opening partially, largely or entirely, as represented in FIGS. 2 and 4.

If the hole 7 is narrowed, is also possible to prevent coarse dust particles from penetrating further into the hole 7.

The component 1, 120, 130, 155 is fitted in a device, preferably a gas turbine 100, while the coating 10 is still present on the component 120, 130, 155 as shown in FIGS. 1, 2 and 3 or FIG. 4.

As a result of the lower removal temperature during commissioning (preferably start-up, test operation, . . . ) in comparison with the maximum operating temperatures of the gas turbine 100, at the lower removal temperatures the protective coating 10 is thermally removed or vaporized by evaporation and burning or a similar chemical process and then exposes the film cooling hole 7 or removes itself from the surface of the component 1, 120, 130, 155. When the newly fitted component 1, 120, 130 is used for the first time, cooling is initially not yet necessary, so that it is quite acceptable for the cooling hole 7 still to be covered by the protective coating 10.

The operating temperature for a gas turbine 100 is ≧800° C., in particular ≧1000° C. The protective layer 10 evaporates, burns or sublimates within the turbine 100, preferably at least at 100° C., in particular ≧200° C., in particular at at least 300° C.

The difference between these two temperatures (operating temperature and removal temperature of the layer 10) is preferably at least 500° C.

If the hole 7 is covered by the layer 10 (FIGS. 2 and 4) or narrowed (FIG. 1), no dirt can penetrate into the hole 7 and temporarily or permanently clog it or constrict it (protection while in transit).

If the color of the layer 10 is different at one point, this is an indication of possible damage, and the component 120, 130, 150 can be examined at this point.

The turbine blades 120, 130 of the first stage of the turbine 100 may preferably be of a different color than the turbine blades 120, 130 of the second stage of the turbine 100 for better differentiation.

Similarly, refurbished and new turbine blades 120, 130, preferably of the same turbine stage, may be of different colors.

Similarly, moving and stationary blades 120, 130 of one turbine stage of a turbine 100 may be of different colors.

Similarly, moving and stationary blades of one turbine stage but of different turbines 100 or types of turbine may be of different colors.

The color does not have to be monochrome.

Protective coatings 10 may also be applied in the case of steam turbines.

FIG. 5 shows a gas turbine 100 by way of example in a longitudinal partial section. The gas turbine 100 has in the interior a rotor 103 with a shaft 101, which is rotatably mounted about an axis of rotation 102 and is also referred to as a turbine runner.

Following one another along the rotor 103 are an intake housing 104, a compressor 105, a combustion chamber 110, for example toroidal, in particular an annular combustion chamber, with a number of coaxially arranged burners 107, a turbine 108 and the exhaust housing 109.

The annular combustion chamber 110 communicates with a hot gas duct 111, for example of an annular form. There, the turbine 108 is formed by four successive turbine stages 112, for example.

Each turbine stage 112 is formed, for example, by two blade rings. As seen in the direction of flow of a working medium 113, a row of stationary blades 115 is followed in the hot gas duct 111 by a row 125 formed by moving blades 120.

The stationary blades 130 are in this case fastened to an inner housing 138 of a stator 143, whereas the moving blades 120 of a row 125 are attached to the rotor 103, for example by means of a turbine disk 133.

Coupled to the rotor 103 is a generator or a machine (not represented).

During the operation of the gas turbine 100, air 135 is sucked in by the compressor 105 through the intake housing 104 and compressed. The compressed air provided at the end of the compressor 105 on the turbine side is passed to the burners 107 and mixed there with a fuel. The mixture is then burned in the combustion chamber 110 to form the working medium 113. From there, the working medium 113 flows along the hot gas duct 111 past the stationary blades 130 and the moving blades 120. At the moving blades 120, the working medium 113 expands, transferring momentum, so that the moving blades 120 drive the rotor 103 and the latter drives the machine coupled to it.

The components that are exposed to the hot working medium 113 are subjected to thermal loads during the operation of the gas turbine 100. The stationary blades 130 and moving blades 120 of the first turbine stage 112, as seen in the direction of flow of the working medium 113, are thermally loaded the most, along with the heat shielding elements lining the annular combustion chamber 110.

In order to withstand the temperatures prevailing there, these may be cooled by means of a coolant.

Similarly, substrates of the components may have a directional structure, i.e. they are monocrystalline (SX structure) or only have longitudinally directed grains (DS structure).

Iron-, nickel- or cobalt-based superalloys are used for example as the material for the components, in particular for the turbine blade 120, 130 and components of the combustion chamber 110.

Such superalloys are known, for example, from EP 1 204 776 B1, EP 1 306 454, EP 1 319 729 A1, WO 99/67435 or WO 00/44949.

Similarly, the blades 120, 130 may have coatings against corrosion (MCrAlX; M is at least one element of the group comprising iron (Fe), cobalt (Co) and nickel (Ni), X is an active element and represents yttrium (Y) and/or silicon, scandium (Sc) and/or at least one element of the rare earths, or hafnium). Such alloys are known from EP 0 486 489 B1, EP 0 786 017 B1, EP 0 412 397 B1 or EP 1 306 454 A1.

A thermal barrier coating, which consists for example of ZrO₂, Y₂O₃—ZrO₂, i.e. is unstabilized, partially stabilized or completely stabilized by yttrium oxide and/or calcium oxide and/or magnesium oxide, may also be present on the MCrAlX.

Columnar grains are produced in the thermal barrier coating by suitable coating methods, such as for example electron-beam physical vapor deposition (EB-PVD).

The stationary blade 130 has a stationary blade root (not represented here), facing the inner housing 138 of the turbine 108, and a stationary blade head, at the opposite end from the stationary blade root. The stationary blade head faces the rotor 103 and is fixed to a fastening ring 140 of the stator 143.

FIG. 6 shows in a perspective view a moving blade 120 or stationary blade 130 of a turbomachine, which extends along a longitudinal axis 121.

The turbomachine may be a gas turbine of an aircraft or of a power plant for generating electricity, a steam turbine or a compressor.

The blade 120, 130 has, following one after the other along the longitudinal axis 121, a fastening region 400, an adjoining blade platform 403 and also a blade airfoil 406 and a blade tip 415.

As a stationary blade 130, the blade 130 may have a further platform at its blade tip 415 (not represented).

In the fastening region 400 there is formed a blade root 183, which serves for the fastening of the moving blades 120, 130 to a shaft or a disk (not represented).

The blade root 183 is designed for example as a hammer head. Other designs as a firtree or dovetail root are possible.

The blade 120, 130 has for a medium which flows past the blade airfoil 406 a leading edge 409 and a trailing edge 412.

In the case of conventional blades 120, 130, solid metallic materials, in particular superalloys, are used for example in all the regions 400, 403, 406 of the blade 120, 130.

Such superalloys are known, for example, from EP 1 204 776 B1, EP 1 306 454, EP 1 319 729 A1, WO 99/67435 or WO 00/44949.

The blade 120, 130 may in this case be produced by a casting method, also by means of directional solidification, by a forging method, by a milling method or combinations of these.

Workpieces with a monocrystalline structure or structures are used as components for machines which are exposed to high mechanical, thermal and/or chemical loads during operation.

The production of monocrystalline workpieces of this type takes place for example by directional solidification from the melt. This involves casting methods in which the liquid metallic alloy solidifies to form the monocrystalline structure, i.e. to form the monocrystalline workpiece, or in a directional manner.

Dendritic crystals are thereby oriented along the thermal flow and form either a columnar grain structure (i.e. grains which extend over the entire length of the workpiece and are commonly referred to here as directionally solidified) or a monocrystalline structure, i.e. the entire workpiece comprises a single crystal. In these methods, the transition to globulitic (polycrystalline) solidification must be avoided, since undirected growth necessarily causes the formation of transversal and longitudinal grain boundaries, which nullify the good properties of the directionally solidified or monocrystalline component.

While reference is being made generally to solidified structures, this is intended to mean both monocrystals, which have no grain boundaries or at most small-angle grain boundaries, and columnar crystal structures, which indeed have grain boundaries extending in the longitudinal direction but no transversal grain boundaries. These second-mentioned crystalline structures are also referred to as directionally solidified structures.

Such methods are known from U.S. Pat. No. 6,024,792 and EP 0 892 090 A1.

Similarly, the blades 120, 130 may have coatings against corrosion or oxidation, for example (MCrAlX; M is at least one element of the group comprising iron (Fe), cobalt (Co) and nickel (Ni), X is an active element and represents yttrium (Y) and/or silicon and/or at least one element of the rare earths, or hafnium (HO). Such alloys are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermal grown oxide layer) forms on the MCrAlX layer (as an intermediate layer or as the outermost layer).

The composition of the layer preferably comprises Co-30Ni-28Cr-8Al-0.6Y-0.7Si or Co-28Ni-24Cr-10Al-0.6Y. Apart from these cobalt-based protective coatings, nickel-based protective coatings are also preferably used, such as Ni-10Cr-12Al-0.6Y-3Re or Ni-12Co-21Cr-11Al-0.4Y-2Re or Ni-25Co-17Cr-10Al-0.4Y-1.5Re.

A thermal barrier coating which is preferably the outermost layer and consists for example of ZrO₂, Y₂O₃—ZrO₂, i.e. is unstabilized, partially stabilized or completely stabilized by yttrium oxide and/or calcium oxide and/or magnesium oxide, may also be present on the MCrAlX.

The thermal barrier coating covers the entire MCrAlX layer.

Columnar grains are produced in the thermal barrier coating by suitable coating methods, such as for example electron-beam physical vapor deposition (EB-PVD).

Other coating methods are conceivable, for example atmospheric plasma spraying (APS), LPPS, VPS or CVD. The thermal barrier coating may have grains which are porous, are provided with microcracks or are provided with macrocracks for better thermal shock resistance. The thermal barrier coating is therefore preferably more porous than the MCrAlX layer.

Refurbishment means that components 120, 130 may have to be freed of protective layers after use (for example by sandblasting). This is followed by removal of the corrosion and/or oxidation layers or products. If need be, cracks in the component 120, 130 are then also repaired. This is followed by recoating of the component 120, 130 and renewed use of the component 120, 130.

The blade 120, 130 may be hollow or be of a solid form. If the blade 120, 130 is to be cooled, it is hollow and may also have film cooling holes 418 (indicated by dashed lines).

FIG. 7 shows a combustion chamber 110 of a gas turbine. The combustion chamber 110 is designed for example as what is known as an annular combustion chamber, in which a multiplicity of burners 107, which produce flames 156 and are arranged in the circumferential direction around an axis of rotation 102, open out into a common combustion chamber space 154. For this purpose, the combustion chamber 110 is designed as a whole as an annular structure, which is positioned around the axis of rotation 102.

To achieve a comparatively high efficiency, the combustion chamber 110 is designed for a comparatively high temperature of the working medium M of approximately 1000° C. to 1600° C. To permit a comparatively long operating time even with these operating parameters that are unfavorable for the materials, the combustion chamber wall 153 is provided on its side facing the working medium M with an inner lining formed by heat shielding elements 155.

Each heat shielding element 155 of an alloy is provided on the working medium side with a particularly heat-resistant protective layer (MCrAlX layer and/or ceramic coating) or is produced from material that is resistant to high temperature (solid ceramic bricks).

These protective layers may be similar to the turbine blades, meaning for example MCrAlX: M is at least one element of the group comprising iron (Fe), cobalt (Co) and nickel (Ni), X is an active element and represents yttrium (Y) and/or silicon and/or at least one element of the rare earths, or hafnium (Hf). Such alloys are known from EP 0 486 489 B1, EP 0 786 017 B1, EP 0 412 397 B1 or EP 1 306 454 A1.

A thermal barrier coating which is for example a ceramic thermal barrier coating and consists for example of ZrO₂, Y₂O₃—ZrO₂, i.e. is unstabilized, partially stabilized or completely stabilized by yttrium oxide and/or calcium oxide and/or magnesium oxide, may also be present on the MCrAlX.

Columnar grains are produced in the thermal barrier coating by suitable coating methods, such as for example electron-beam physical vapor deposition (EB-PVD).

Other coating methods are conceivable, for example atmospheric plasma spraying (APS), LPPS, VPS or CVD. The thermal barrier coating may have grains which are porous, are provided with microcracks or are provided with macrocracks for better thermal shock resistance.

Refurbishment means that heat shielding elements 155 may have to be freed of protective layers after use (for example by sandblasting). This is followed by removal of the corrosion and/or oxidation layers or products. If need be, cracks in the heat shielding element 155 are then also repaired. This is followed by recoating of the heat shielding elements 155 and renewed use of the heat shielding elements 155.

On account of the high temperatures in the interior of the combustion chamber 110, a cooling system may also be provided for the heat shielding elements 155 or for their holding elements. The heat shielding elements 155 are for example hollow and, if need be, also have cooling holes (not represented) opening out into the combustion chamber space 154.

1.-15. (canceled)

16. A turbine component, comprising:
an outer hole; and
an outermost layer comprising a protective coating,
wherein the turbine component is used at high operating temperatures,
wherein the outermost layer may be easily removed by the effect of heat at lower removal temperatures in comparison with the high operating temperatures of the turbine component, and wherein the protective coating comprises a polymer.

17. The turbine component as claimed in claim 16, wherein the protective coating consists of a polymer.

18. The turbine component as claimed in claim 16, wherein the outer hole is a through-hole.

19. The turbine component as claimed in claim 16, wherein the protective coating at least partially covers an opening of the outer hole.

20. The turbine component as claimed in claim 16, wherein the protective coating substantially covers an opening of the outer hole.

21. The turbine component as claimed in claim 16, wherein the protective coating completely covers the opening of the outer hole.

22. The turbine component as claimed in claim 16, wherein the protective coating is arranged in the outer hole.

23. The turbine component as claimed in claim 16, wherein the outer hole with the protective coating pass through the protective coating.

24. The turbine component as claimed in claim 16, wherein the protective coating is present on a ceramic coating.

25. The turbine component as claimed in claim 16, wherein the protective coating comprises a dye.

26. The turbine component as claimed in claim 16, wherein the coating comprises only one dye.

27. The turbine component as claimed in claim 16, wherein a removal temperature is at least 100° C.

28. The turbine component as claimed in claim 27, wherein the removal temperature is at least 200° C.

29. The turbine component as claimed in claim 16, wherein a difference between an operating temperature of the turbine component and a removal temperature, as from which the protective coating is removed is at least 400° C.

30. The turbine component as claimed in claim 29, wherein the difference between an operating temperature of the turbine component and the removal temperature, as from which the protective coating is removed is at least 500° C.

31. The turbine component as claimed in claim 16, wherein a first plurality of turbine components of a turbine are a different color than a second plurality of turbine components of the turbine.

32. The turbine components as claimed in claim 16, wherein a first plurality of turbine components of a first turbine are a different color than a second plurality of turbine components of a second turbine of the same type as the first turbine.

33. A method for protecting a turbine component, comprising:
providing a turbine component as claimed in claim 16;
applying the protective coating to the component as the outermost layer; and
fitting the turbine component in a turbine,
wherein the applying is done before the fitting, and
wherein the coating is at least partially removed by the effect of heat within the turbine during the initial commissioning of the turbine with the newly fitted or already fitted component as a result of the commissioning.

34. The method as claimed in claim 33, wherein the protective coating is applied to a ceramic layer.

35. The method as claimed in claim 33, wherein the protective coating is no longer present when an operating temperature of the turbine reaches a temperature of 300° C.
